(19) United States
(12) Patent Application Publication
(10) Pub. No.: US 2022/0171713 A1
(43) Pub. Date: Jun. 2, 2022

(54) TEMPERATURE-AWARE DATA MANAGEMENT IN MEMORY SUB-SYSTEMS

(71) Applicant: MICRON TECHNOLOGY, INC., Boise, ID (US)

(72) Inventors: Ashutosh Malshe, Fremont, CA (US); Sampath Ratnam, San Jose, CA (US); Kishore Kumar Muchherla, Fremont, CA (US); Peter Feeley, Boise, ID (US)

(21) Appl. No.: 17/399,997

(22) Filed: Aug. 11, 2021

Related U.S. Application Data
(60) Provisional application No. 63/119,527, filed on Nov. 30, 2020.

(51) Int. Cl. G06F 12/10; G06F 12/02

(52) U.S. Cl. CPC G06F 12/10; G06F 2212/1044; G06F 12/0253

(57) ABSTRACT

At least one source physical memory block stored in a memory device is identified. The source physical memory block comprises at least one logical unit. A determination is made as to whether an age characteristic of the logical unit satisfies a threshold criterion. A storage classification is determined for the logical unit based on whether the age characteristic of the logical unit satisfies the threshold criterion. The classification comprises a hot data classification or a cold data classification. A target physical memory block is identified based on the storage classification determined for the logical unit, and the logical unit is stored in the identified target physical memory block.

### PRIORITY

This application claims the benefit of U.S. Provisional Patent Application No. 63/119,527, filed Nov. 30, 2020, which is incorporated herein by reference.

### TECHNICAL FIELD

Embodiments of the disclosure relate generally to memory sub-systems, and more specifically, relate to temperature-aware data management in memory subsystems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a flow diagram of an example method to perform temperature-aware data management operations in accordance with some embodiments of the present disclosure.

FIG. 3A illustrates an example of logical units having version and relocation counters in accordance with some embodiments of the present disclosure.

FIG. 3B illustrates an example of updating logical unit version counters in accordance with some embodiments of the present disclosure.

FIGS. 4A-4C illustrate an example of updating logical unit relocation counters in accordance with some embodiments of the present disclosure.

FIGS. 5A and 5B illustrate an example of separating cold logical units from hot logical units in accordance with some embodiments of the present disclosure.

FIG. 6A illustrates a flow diagram of an example method to relocate a logical unit to a memory block that corresponds to a temperature classification of the logical unit using single-cursor addressing in accordance with some embodiments of the present disclosure.

FIG. 6B illustrates a flow diagram of an example method to relocate a logical unit to a memory block that corresponds to a temperature classification of the logical unit using multi-cursor addressing in accordance with some embodiments of the present disclosure.

FIG. 7 illustrates a flow diagram of an example method to relocate a logical unit to a memory block that corresponds to a temperature classification of the logical unit using background processing in accordance with some embodiments of the present disclosure.

FIG. 8 is a block diagram of an example computer system in which embodiments of the present disclosure can operate.

### DETAILED DESCRIPTION

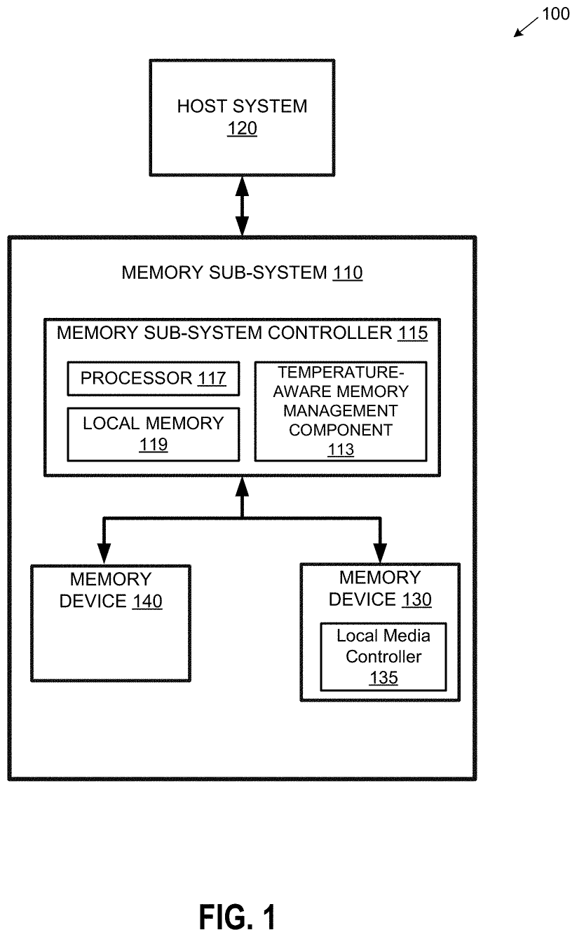

Aspects of the present disclosure are directed to temperature-aware data management in memory sub-systems. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For some types of non-volatile memory devices (e.g., negative-and (NAND) devices), data is stored in a set of physical blocks. Each block consists of a set of pages (“physical pages”). Each page consists of a set of memory cells, each of which can store one or more bits of data. For some memory devices, such as NAND devices, blocks are the smallest area than can be erased and pages within the blocks cannot be erased individually. For such devices, erase operations are performed one block at a time. A page of a block can contain valid data, invalid data, or no data. Invalid data is data that is marked as outdated as a new version of the data is stored on the memory device. Valid data is the most recent version of such data being stored on the memory device. A memory sub-system can mark data as invalid based on information received, for example, from an operating system. A page that does not contain data includes a page that has been previously erased, and not yet written to.

Although the memory devices store data in pages and blocks of particular sizes, the memory sub-system can provide support for units of other sizes, and map the units to pages or physical blocks. Each such unit is referred to herein as a logical unit, and can be, for example, a physical page, a physical block, a host logical block, a multiple of a physical block, or other suitable size. The data stored in each logical unit can include metadata and host data.

The data provided by the host system to be stored at the memory sub-system can be logical units of data, some of which are written to, or overwritten in, the memory devices by the host more frequently than others. The frequently-written data is referred to as “hot data” and can include journals, file system metadata, and other frequently-updated data. The infrequently-written data is referred to as “cold data” and can include operating system data that rarely changes, media files, and other data that is static or rarely updated.

Garbage collection operations are performed by certain types of conventional memory sub-systems in which an existing block of data must be erased before any data on the block can be rewritten. Garbage collection operations can be initiated by the memory sub-system to copy existing data to new blocks so that a portion of the existing data can be changed. However, cold data is unlikely to change. Unchanged cold data that is located on the same memory blocks as hot data is likely to be copied to new blocks numerous times by garbage collection operations because of changes to the hot data located on the same blocks. This repeated writing of data that has been previously written, referred to as write amplification, reduces the performance of the memory sub-system. The repeated write operations can reduce response time and throughput, and also reduce the lifespan of the memory devices that store the data. Further, “hot blocks” that contain primarily hot data are more likely to be selected for garbage collection because hot data is frequently invalidated, and garbage collection algorithms select blocks having the lowest amount of valid data for garbage collection. Any cold data that is stored in the hot blocks increases garbage collection effort and write amplification, as described above, and is more likely to be processed by in garbage collection operations because it is in the same blocks as hot data. “Cold blocks” that contain static of cold data that is primarily valid and rarely updated are less likely to be selected for garbage collection, and any invalid hot data that is stored in the cold blocks reduces the amount of available storage, and can reduce the amount of data reserved by the storage sub-system for its own operations (which is referred to as reducing “over provisioning”).

Aspects of the present disclosure address the above and other deficiencies by having a temperature-aware memory sub-system that can determine temperature classifications for data and store or move data of different temperature classifications to corresponding different blocks of physical memory. As a result, cold data is located in cold blocks, hot data is located in hot blocks (and so on, if there are other memory classifications, such as warm data). The temperature-aware memory sub-system can determine the temperature classification for a logical unit based on characteristics of the logical unit related to the logical unit's age. The age-related characteristics can include a version counter that is incremented each time the logical unit is written to a memory device and can be used to determine a relative age of the logical unit.

Advantages of the present disclosure include, but are not limited to, improvements in the performance of the memory sub-system resulting from the storage of data of different temperatures in different blocks of physical memory. Since the amount of cold data stored in primarily hot blocks is reduced, the garbage collection operations and write amplification are reduced. The reduced write amplification can provide for improved performance of the memory sub-system as fewer write operations are performed as part of the garbage collection operation, and increased storage efficiency. The reduction in the number of writes to blocks of physical memory can also increase the operating lifespan of the memory sub-system, since fewer write operations are performed as part of the garbage collection operations. Further, since the amount of hot data stored in primarily cold blocks is reduced, over-provisioning is also reduced, and storage efficiency is improved because more memory blocks are available for use by the memory sub-system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130. 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which includes a raw memory device 130 having control logic (e.g., local controller 132) on the die and a controller (e.g., memory sub-system controller 115) for media management within the same memory device package. An example of a managed memory device is a managed NAND (MNAND) device.

The memory sub-system controller 115 can perform operations for media management algorithms, such as wear leveling, refresh, garbage collection, scrub, etc. A block can have some pages containing valid data and some pages containing invalid data. To avoid waiting for all of the pages in the block to have invalid data in order to erase and reuse the block, an algorithm hereinafter referred to as “garbage collection” can be invoked to allow the block to be erased and released as a free block for subsequent write operations. Garbage collection is a set of media management operations that include, for example, selecting a block that contains valid and invalid data, selecting pages in the block that contain valid data, copying the valid data to new locations (e.g., free pages in another block), marking the data in the previously selected pages as invalid, and erasing the selected block.

Since garbage collection can write the valid data to a different block before the block is erased, data can be rewritten many times to different blocks at the memory sub-system. The amount of additional rewrites of data in the memory sub-system is referred to herein as write-amplification. Write-amplification can reduce the operating life of a memory sub-system. To reduce write-amplification, the memory sub-system can include some amount of additional blocks in excess to a total number of blocks that are available at any single time to store data from the host system. Such additional blocks can be considered over-provisioning. A larger amount of over-provisioning can significantly reduce write-amplification as the number of times that data is rewritten within the memory sub-system due to garbage collection attempting to free up blocks is reduced.

“Garbage collection operation” hereinafter refers to selecting a block, rewriting the valid data from the selected block to a new block, and erasing all invalid data and valid data stored at the selected block. The valid data from multiple selected blocks can be copied to a smaller number of new blocks and the selected blocks can then be erased. As a result, the number of blocks that have been erased can be increased so that more blocks are available to store subsequent data from a host system.

To select a block on which the garbage collection operation is to be performed, the conventional memory sub-system selects the block with the least amount of valid data as less valid data is required to be rewritten from the selected block to a new block before the selected block is erased. In some circumstances, a block can include data that is valid for a relatively long period of time. Such data is referred to as cold data. If a block includes a large amount of valid cold data, then the garbage collection operation may not be performed on the block. As a result, fewer garbage collection operations are performed on the block compared to other blocks with lesser amounts of valid data that will be selected by the garbage collection operation. Since the garbage collection operation is not performed on the blocks with large amounts of valid cold data, a significant amount of the capacity of the memory sub-system is locked up in blocks that contain some amount of invalid data along with the valid cold data. The number of blocks that store cold data reduces the amount of overprovisioning in the memory sub-system and therefore causes an increase in write-amplification as additional write operations are performed on other blocks and are not performed on the blocks with the valid cold data.

The memory sub-system 110 includes a temperature-aware memory management component 113 that can determine temperature classifications for data and store or move data of different temperature classifications to corresponding different blocks of physical memory (e.g., in memory device 130). In some embodiments, the memory sub-system controller 115 includes at least a portion of the temperature-aware memory management component 113. In some embodiments, the temperature-aware memory management component 113 is part of the host system 110, an application, or an operating system. In other embodiments, local media controller 135 includes at least a portion of temperature-aware memory management component 113 and is configured to perform the functionality described herein. determine temperature classifications for data and store or move data of different temperature classifications to corresponding different blocks of physical memory (e.g., in memory device 130).

The temperature-aware memory management component 113 can determine the temperature classification for a logical unit based on characteristics of the logical unit related to the logical unit's age, identify a block of memory that corresponds to the temperature classification, and store or move the logical unit to the corresponding block of memory. Further details with regards to the operations of the temperature-aware memory management component 113 are described below.

In particular embodiments, the age-related characteristics used by the temperature-aware memory management component 113 to determine the temperature classification for a logical unit can include a version counter that is incremented each time the logical unit is written to a memory device and can be used to determine a relative age of the logical unit. The version counter can be implemented using a “current version counter” variable that is incremented each time any logical unit in a set of logical units (e.g., in a block of physical memory in memory device 130) is written to. The age of a logical unit can then be determined by subtracting the logical unit's version counter from the current version counter. Larger differences correspond to older logical units, which can be classified as cold data. Smaller differences correspond to newer logical units, which can be classified as hot data. A threshold version value can be used to determine whether to classify a logical unit as hot or cold. For example, if the difference between the current version counter and the logical unit's version counter is greater than the threshold version value, then the logical unit can be classified as cold data. Otherwise, the logical unit can be classified as hot data.

The age-related characteristics can also include a relocation counter that is incremented each time the logical unit is relocated to a different block and reset when the logical unit is over-written. Lower values of the relocation counter indicate that the logical unit has likely been overwritten more recently than do higher relocation counters, and is thus relatively new compared to logical units having higher relocation counters. Thus, lower values of the relocation counter correspond to hot data, and higher values correspond to cold data. A threshold relocation value can be used to determine whether to classify a logical unit as hot or cold. For example, if the relocation counter is greater than the threshold relocation value, then the logical unit can be classified as cold data. Otherwise, the relocation counter can be classified as hot data.

When more than one of the different age characteristics are determined, a combination of the threshold values for the different age characteristics can be used to classify a logical unit as hot or cold. For example, a weighted average of the version counter and the relocation counter can be determined and compared to a threshold weighted combination value. The weighted average can weight each characteristic equally. Alternatively, each characteristic can have a different weight. The temperature classification, and movement of logical units of data to different blocks based on the temperature classification, can occur, for example, when garbage collection is performed, or at other times, such as during idle time (e.g., when the storage sub-system is not performing read or write operations).

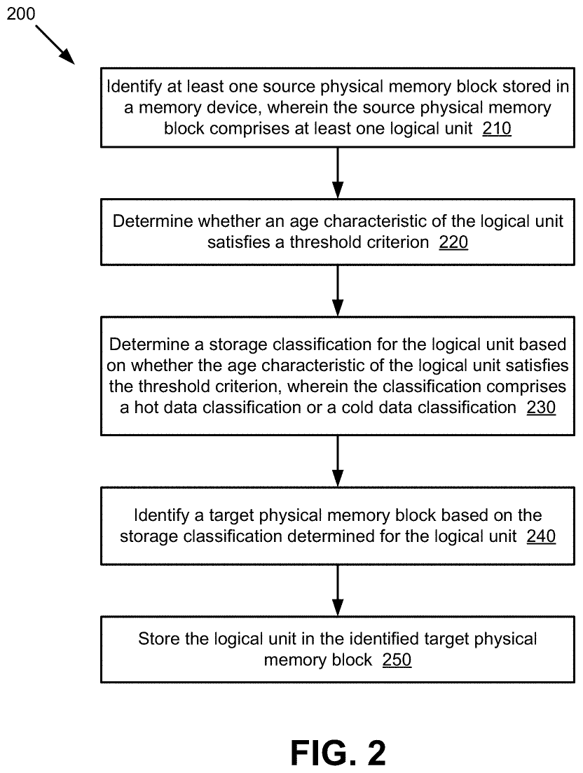

FIG. 2 is a flow diagram of an example method 200 to perform temperature-aware data management operations, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the temperature-aware memory management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 210, the processing logic identifies at least one source physical memory block stored in a memory device 130. The source physical memory block includes at least one logical unit. Operation 210, and other operations of the method 200, can be performed in response to a garbage collection event, e.g., by a foreground process that performs garbage collection operations.

At operation 220, the processing logic determines whether an age characteristic of the logical unit satisfies a threshold criterion. The age characteristic of the logical unit can be a version count based on a number of times the data of the logical unit has been written to at least one physical block of the memory device, in which case the threshold criterion is a threshold version count. The determined storage classification for the logical unit can be the hot data classification when a difference between the version count of the logical unit and a current version value satisfies a threshold version difference. When the determined storage classification is the hot data classification, the target physical memory block can include a hot data physical memory block designated as storing hot data.

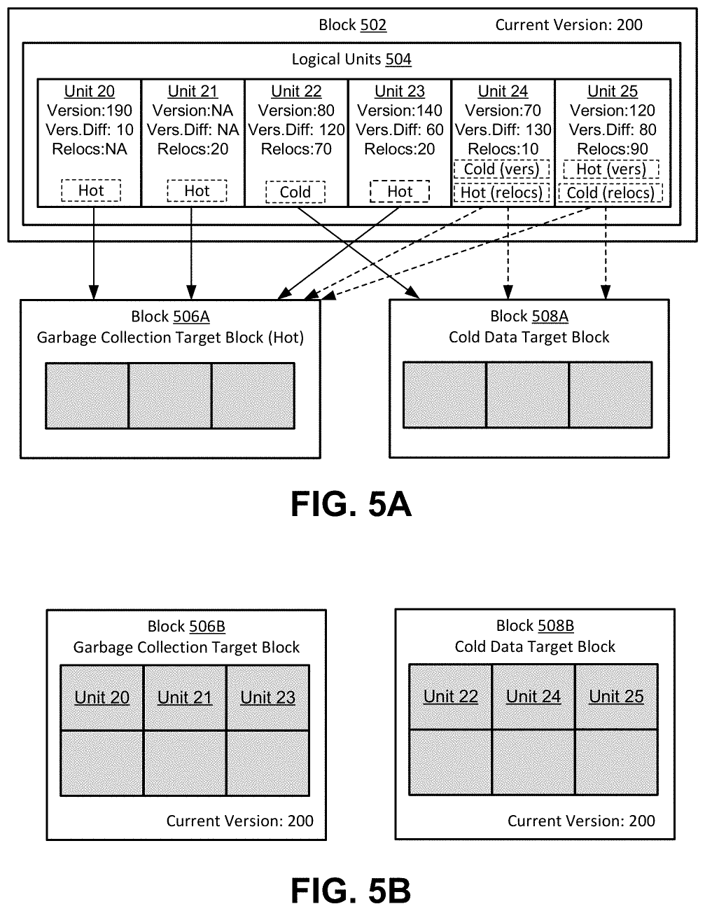

The determined storage classification for the logical unit can be the cold data classification when a difference between the version count of the logical unit and a current version count satisfies a threshold version difference, e.g., as described with reference to FIG. 5A. When the determined storage classification for the logical unit is the cold data classification, the target physical memory block can include a cold data physical memory block designated as storing cold data.

The age characteristic of each logical unit can be a relocation count based on a number of times the logical unit has been relocated or otherwise moved from to a different memory block of the memory device. The relocation count can be reset to an initial value, such as 0, when the logical unit is over-written in the memory device, since over-writing the logical unit corresponds to resetting the age of the logical unit to indicate that the logical unit contains new data. The determined storage classification for the logical unit can be based on whether the relocation count satisfies a threshold relocation condition, as described with reference to FIG. 5A. For example, the determined storage classification for the logical unit can be the cold data classification when the relocation count satisfies a threshold relocation count, or the hot data classification when the relocation count does not satisfy the threshold relocation count.

At operation 230, the processing logic determines a storage classification for the logical unit based on whether the age characteristic of the logical unit satisfies the threshold criterion, wherein the classification includes a hot data classification or a cold data classification. At operation 240, the processing logic identifies a target physical memory block based on the storage classification determined for the logical unit. At operation 250, the processing logic stores the logical unit in the identified target physical memory block. The processing device can store an address of the logical unit in a set of cold data logical unit addresses, such as a journal or log. Each logical unit identified by an address in the journal is moved to the cold data physical memory block when the set of cold data logical unit addresses satisfies a threshold size condition, e.g., when the size of the log reaches a threshold size, such as a buffer size or the like. The processing device can use a background task to store the address of the logical unit in the journal during background idle time. In particular embodiments, the processing device can use a background task to perform each of the operations of the method 200.

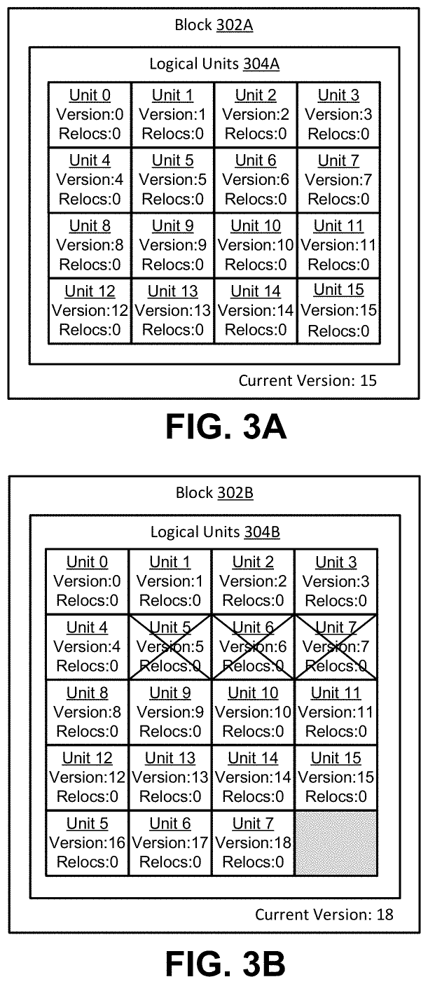

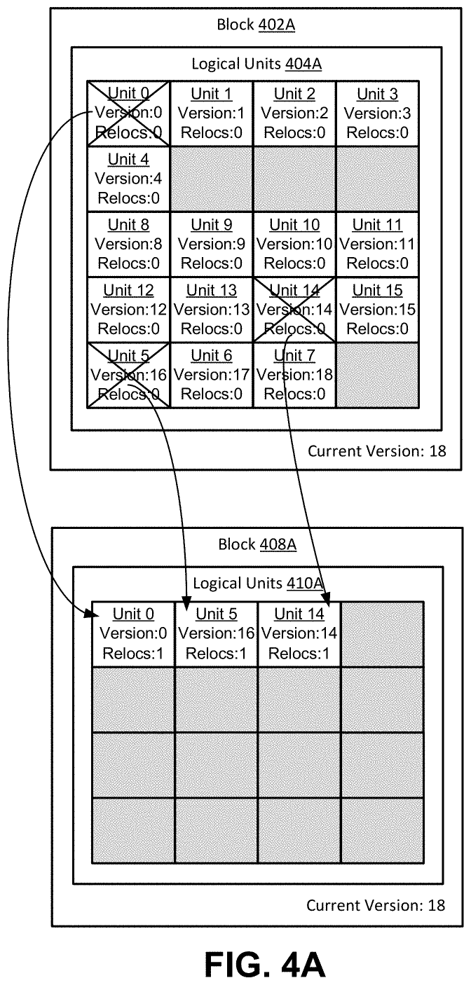

FIG. 3A illustrates an example of logical units having version and relocation counters in accordance with some embodiments of the present disclosure. A block 302A, which can be a physical memory block located in memory device 130, contains sixteen logical units in a set of logical units 304A. The logical units are labeled “Unit: 0” through “Unit: 16.” Each of the logical units 304A can be, for example, a physical page, a physical block, a host logical block, a multiple of a physical block, or other suitable size. Each of the logical units 304A can contain host data (not shown) and metadata. Characteristics of a logical unit, such as a unit identifier, a version counter, and a relocation counter, can be stored in the metadata of the logical unit, or in other memory area (e.g., the version counter and relocation counter can be stored in a table separately from the logical units 304A and associated with the logical unit by the logical unit identifier).

Each logical unit (“Unit”) in FIG. 3A includes a unit identifier (shown as “Unit X” where X is the unit identifier), a version counter (“Version: X” where X is the value of the version counter), and a relocation counter (“Relocs: X”, where X is the value of the relocation counter). The version counters of Units 0 through 15 in the set of logical units 304A are 0 through 15 (Version: 0 through Version: 15), respectively, which indicate the ages of the respective logical units. The relocation counters of Units 0 through 15 are all 0 (Relocs: 0), which indicates that none of Units 0 through 15 have been relocated to other blocks.

The version counter values can be assigned to the logical units by incrementing a current version value each time data is written to a logical unit of the block 302A by the host, and setting the value of the version counter of the logical unit to the current version value. The current version value (shown as “Current Version: 15”) represents a most-recently-assigned version counter value (or a next version counter value to be assigned). The current version value can be stored in the block 302A or elsewhere in a memory accessible to the temperature-aware memory management component 113. The age of a logical unit can be determined by subtracting the logical unit's version counter from the current version value, which is 15 in this example. For example, the age of Unit 0 is 15 (15−0), and the age of unit 14 is 1 (15−14). Since 15 is greater than 1, Unit 0 is older than Unit 14. Other techniques can be used to assign values to the version counters, e.g., initializing the version counter to 0 the first time a logical unit is written, and incrementing the version counter of the logical unit when the logical unit is written.

The relocation counter values can be assigned to the logical units by setting (or resetting) the relocation counter of each logical unit to an initial value, such as 0, each time data is written to the logical unit by the host. Each time a logical unit is relocated to a different block of physical memory, e.g., by a garbage collection process performed by the memory sub-system controller 115, the relocation counter can be incremented. The particular values shown, e.g., the unit number, version counter, relocation counter, and current version value, and the number of logical units shown, are merely shown as illustrative examples, and any suitable values can be used instead of the values shown.

FIG. 3B illustrates an example of updating logical unit version counters in accordance with some embodiments of the present disclosure. A block 302B, which can be a modified version of the physical memory block 302A of FIG. 3A, contains a set of logical units 304B. The logical units 306B can be produced by the memory sub-system controller 115 overwriting Units 5, 6, and 7 of the logical units 304A. As a result, Units 5, 6, and 7 of the logical units 304A become invalid, as shown by an X over each of Units 5, 6, and 7 in the second row of logical units 304B, and Units 5, 6, and 7 are rewritten to different locations in the block 302B (e.g., with host data that is different from the host data of the invalidated initial Units 5, 6, and 7 shown in the second row. The version counters of new Units 5, 6, and 7 are determined based on the current version value, which is initially 15 prior to the rewriting of Units 5, 6, and 7. When Unit 5 is rewritten, the current version value is incremented to 16, and its value (16) is used as the version counter for Unit 5 (shown as “Version: 16” in Unit 5). Similarly, when Unit 6 is rewritten, the current version value is incremented to 17, and its value (17) is assigned to Unit 6, resulting a version counter of 17 for Unit 6 (shown as “Version: 17” in Unit 6). The version counter for Unit 7 is set to 18 by a similar sequence of operations (shown as “Version: 18” in Unit 7). The current version value is then 18.

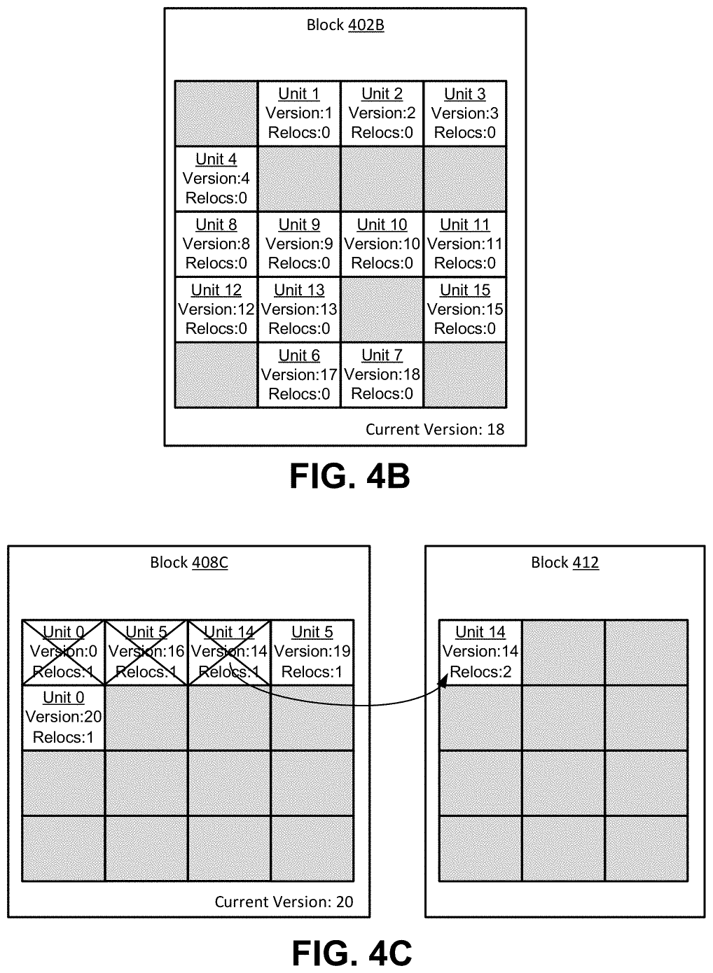

FIGS. 4A-4C illustrate an example of updating logical unit relocation counters in accordance with some embodiments of the present disclosure. As shown in FIG. 4A, a block 402A, which can be a modified version of the physical memory block 302B of FIG. 3B, contains a set of logical units 404A. The logical units 404A can be produced by the memory sub-system controller 115 relocating Units 0, 5, and 14 of the logical units 304B to a different block 408A. This relocation can occur as part of a garbage collection operation, for example. As a result of the relocation, Units 0, 5, and 14 of the logical units 404A have become invalid, as shown by an X over each of Units 0, 5, and 14. Further, Units 0, 5, and 14 have been moved to block 408A, where they are included in a set of logical units 410A. Since each of Units 0, 5, and 14 have been relocated once, the relocation count of each unit has been incremented by 1. The relocation counts of Units 0, 5, and 14 in logical units 410A are shown as “Relocs: 1” in indicate that each of those logical units has a relocation count of 1. The data of each of Units 0, 5, and 14 can be copied from block 402A to block 408A as part of the relocation process.

The logical units of Block 402A subsequent to the location are shown in FIG. 4B as block 402B. As can be seen in block 402B, the locations at which the relocated Units 0, 5, and 14 were stored prior to relocation are invalid, as shown by empty blocks in those locations. The locations at which overwritten Units 5, 6, and 7 were stored prior to being overwritten are also invalid, as shown by empty blocks in those locations.

FIG. 4C illustrates the effects of two more example rewrites and another example relocation on the logical units 410A of block 408A of FIG. 4A. As shown in FIG. 4A, block 408A contains Units 0, 5, and 14. In the first example rewrite, Unit 5 is rewritten, e.g., because the host has requested that a portion of the host data in Unit 5 be changed. When Unit 5 is rewritten, the version of Unit 5 in block 410A is invalidated (as shown by an X over the location of Unit 5 in block 408C). Unit 5 is rewritten to a different location in block 408C (shown in the fourth column of the first row). The version counter of the rewritten Unit 5 is determined by incrementing the current version value, 18, to 19, and assigning the result (19) to the version counter for Unit 5 (as shown by “Version: 19”). The data, including host data and metadata, of Unit 5 is copied, so the relocation counter remains 1 (as shown by “Relocs: 1” in Unit 5).

In the second example rewrite, Unit 0 is rewritten, e.g., because the host has requested that a portion of the host data or host-accessible metadata (such as operating system metadata) in Unit 0 be changed. When Unit 0 is rewritten, the version of Unit 0 in block 410A is invalidated (as shown by an X over the location of Unit 0 in block 408C). Unit 0 is rewritten to a different location in block 408C (shown in the first column of the second row). The version counter of the rewritten Unit 0 is determined by incrementing the current version value, 19, to 20, and assigning the result (20) to the version counter for Unit 0 (as shown by “Version: 20”).

In an example relocation, Unit 14 is relocated to block 410, e.g., as a result of a garbage collection operation. When Unit 14 is relocated, the version of Unit 14 in block 410A is invalidated (as shown by an X over the location of Unit 14 in block 408C), and Unit 14 is copied to block 412. Unit 14's relocation counter is incremented from 1 to 2 as a result of the relocation (as shown by “Relocs: 2” in Unit 14 of block 412). The metadata (e.g., version counter) and host data of Unit 14 is copied from block 408C to block 412 during the relocation (as shown by “Version: 14” in Unit 14 of block 412).

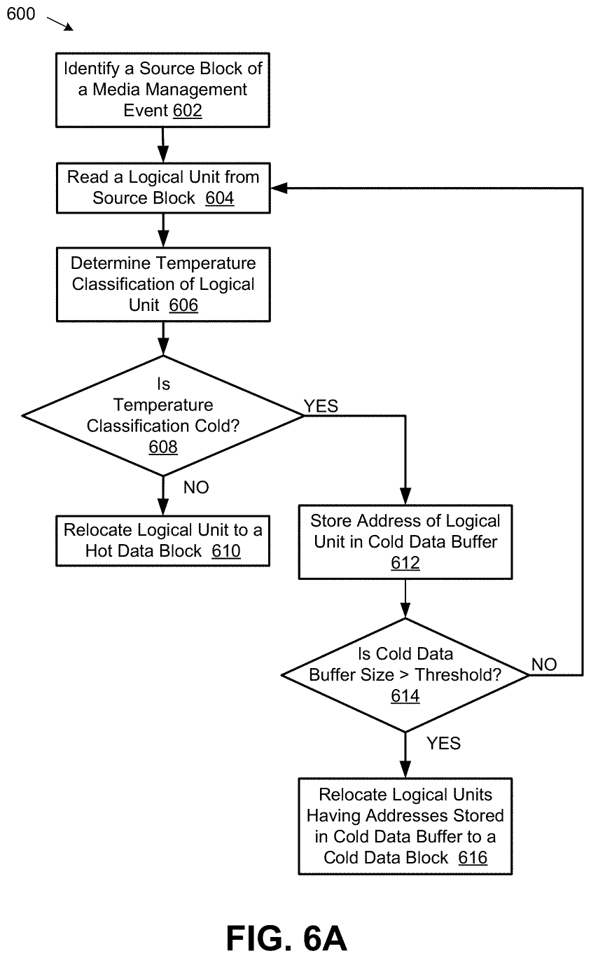

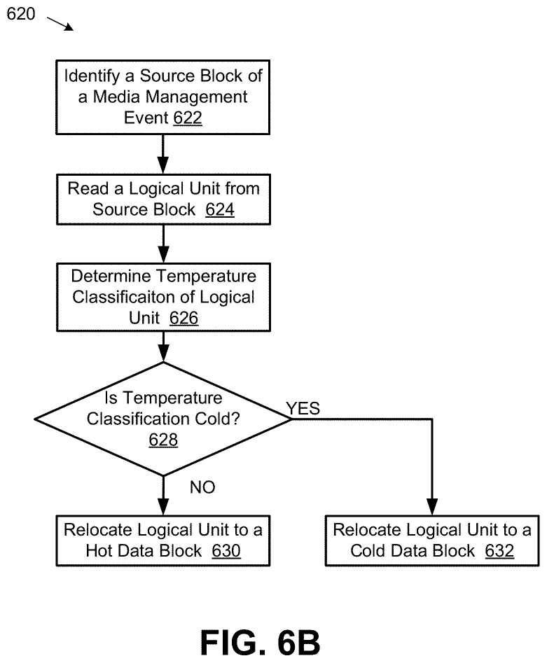

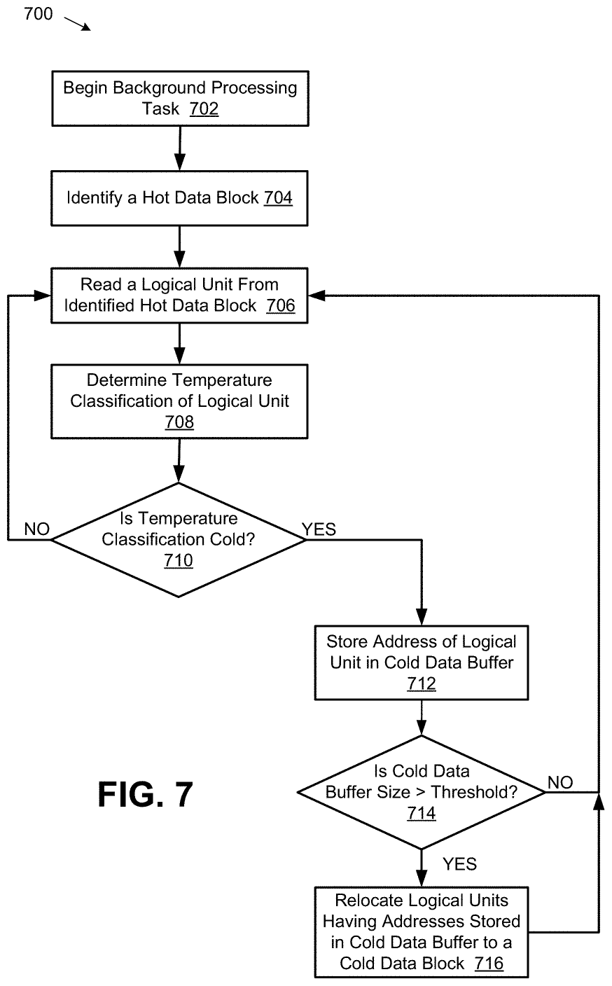

FIGS. 5A and 5B illustrate an example of separating cold logical units from hot logical units in accordance with some embodiments of the present disclosure. A block 502 contains logical units 504, which are named Unit 20 through Unit 25. The temperature-aware memory management component 113 classifies each of the logical units 504 as hot data or cold data based on the logical unit's age characteristics (version counter and relocation counter). The temperature-aware memory management component 113 can perform the classification as part of or in response to a garbage collection operation (e.g., in a foreground process), as described further with reference to FIGS. 6A and 6B. Alternatively or additionally, the temperature-aware memory management component 113 can perform the classification during idle time (e.g., in a background process), as described further with reference to FIG. 7. The temperature-aware memory management component 113 can also relocate logical units 504 to blocks 506A, 508A (e.g., in physical memory) that are identified based on the classifications determined for the blocks.

Logical units 504 that are classified as hot data can be relocated to a block 506A that corresponds to hot data. The block 506A can be, for example, a garbage collection target block to which a garbage collection operation relocates blocks. Units 20, 21, and 23, for example, are classified as hot data, and are relocated to garbage collection target block 506A. Units 24 and 25 can be classified as either hot or cold, depending on which age characteristic is used. If classified as hot data, Units 24 and 25 are also relocated to block 506A.

Logical units 504 that are classified as cold data can be relocated to a block 508A, which is a designated cold data target block. Unit 22, for example, is classified as cold data, and is relocated to cold data target block 508A. Units 24 and 25, which can be classified as either hot or cold, are relocated to cold data target block 508A if they are classified as cold data.

The age characteristics of Units 20-25 used to determine the temperature classifications of the units are shown in Table 1, along with the determined temperature classifications.

TABLE 1

| Logical Unit | Version | Version | Relocation | Temperature |
|---|---|---|---|---|
| ID | Counter | Difference | Counter | Classification |
| 20 | 190 | 10 | Not | Hot |
| | | | Available | |
| 21 | Not | Not | 20 | Hot |
| | Available | Available | | |
| 22 | 80 | 120 | 70 | Cold |
| 23 | 140 | 60 | 20 | Hot |
| 24 | 70 | 130 | 10 | Cold (by version) or |
| | | | | Hot (by relocations) |
| 25 | 120 | 80 | 90 | Hot (by version) or |
| | | | | Cold (by relocations) |

The Version Difference column shows the difference between the Version Counter of each logical unit and the current version value, which is 200. The version difference is proportional to an age of the logical unit. The relocation counter is also proportional to an age of the logical unit, since a larger number of relocations indicates that the logical unit has likely existed for a longer period of time than a smaller number of relocations. The temperature classification can be determined based on the version difference, the relocation counter, or both. To determine the temperature of a logical unit based on its version counter, the version difference can be compared to a threshold version difference. If the version difference is greater than the threshold, then the logical unit can be classified as cold data. Otherwise (e.g., if the version difference is less than or equal to the threshold), the logical unit can be classified as hot data. The threshold version difference can be determined based on particular expected workloads for which the threshold version difference value can be used to classify logical units as cold data with acceptable accuracy. An empirical tuning process can thus be used to determine an appropriate threshold version difference based on particular expected workloads.

In the example of FIG. 5A, the threshold version difference is 100, so version differences greater than 100 can be classified as cold data. Alternatively or additionally, to determine the temperature of a logical unit based on its version counter, the version counter can be compared to a threshold version counter. If the version counter is greater than the threshold version counter, then the logical unit can be classified as cold data. The threshold version counter can be, for example, a value that is less than the current version value minus the threshold version distance. If the version counters are incremented independently of each other, e.g., version counters are updated by incrementing them instead of by setting them to the current version value, then the threshold version counter can be determined by subtracting the threshold version difference from the version counter of the logical unit.

In the example of FIG. 5A, according to the version counter, Unit 20 is classified as hot data because its version difference is 10, which is less than the threshold version difference (as described above, version differences greater than the threshold version difference value of 100 are classified as cold data). Unit 21 is not classified based on its version counter because the version counter is not available for Unit 21, as can occur if version counters are not implemented in particular cases, such as for classifications performed by background processes. That is, for example, foreground and background processes can use different age characteristics. Foreground processes, such as the methods shown in FIGS. 6A and 6B, can use the version counter to determine temperature classification, for example. Background processes, such as the method shown in FIG. 7, can use the relocation counter to determine temperature classification (or vice-versa). Unit 22 is classified as cold data because its version difference is 120, which is greater than the threshold version difference. Unit 23 is classified as hot data because its version difference is 60, which is less than the threshold version difference. Unit 24 is classified as cold data according to its version counter because its version difference is 130, which is greater than the threshold version difference. Unit 25 is classified as hot data according to its version counter because its version difference is 80, which is less than the threshold version difference.

To determine the temperature of a logical unit based on its relocation counter, the relocation counter can be compared to a threshold relocation counter. If the relocation counter is greater than the threshold, then the logical unit can be classified as cold data. Otherwise (e.g., if the version difference is less than or equal to the threshold), the logical unit can be classified as hot data. The threshold relocation counter can be determined based on expected workloads as described above for the threshold version distance.

In the example of FIG. 5A, In this example, the threshold relocation counter is 50, so relocation counters greater than 50 can be classified as cold data. Unit 20 is not classified according to its relocation counter because its relocation counter is not available, as can occur if relocation counters are not implemented in particular cases, such as for classifications performed by foreground processes. According to its relocation counter, Unit 21 is classified as hot data because its relocation counter, which is 20, is less than the relocation counter threshold (as described above, relocation counters greater than the threshold relocation counter value of 50 are classified as cold data). Unit 22 is classified as cold data because its relocation counter, which is 70, is greater than the relocation counter threshold. Unit 23 is classified as hot data because its relocation counter, which is 20, is less than the relocation counter threshold. Unit 24 is classified as hot data according to its relocation counter because its relocation counter, which is 10, is less than the relocation counter threshold. Unit 25 is classified as cold data according to its relocation counter because its relocation counter, which is 90, is greater than the relocation counter threshold.

In particular embodiments, to determine the temperature of a logical unit based on both its version counter and its relocation counter, the version counter can be compared to the threshold version difference and the relocation counter can be compared to the threshold relocation counter. If both counters produce the same classification (e.g., both correspond to hot data or both correspond to cold data), then the classification can be used as the determined temperature. However, if the version counter comparison produces a result that disagrees with the relocation counter, a decision can be made as to whether the classify the logical unit as hot data or cold data, e.g., by giving precedence to the classification produced by one of the age characteristics (e.g., versions or relocations), or by a heuristic such as selecting the classification that is farther from its threshold. The values of different classification are not necessarily directly comparable. For example, 10 relocations can be a stronger indication that a logical unit is cold than 10 versions, e.g., since relocations can be less frequent than version increments. Thus, comparisons between values of different characteristics can involve scaling one of the characteristics (e.g., multiplying relocations by 3) prior to performing the comparison. Selecting a classification that is farther from the threshold can involve scaling at least one of the characteristic values (e.g., versions, relocations, or both) prior to comparing the differences of different characteristic values from their thresholds. In other embodiments, the classification result can be considered invalid if the classifications based on two different age characteristics of a logical unit do not agree, in which case the temperature-aware memory management component 113 can determine that no action is to be performed for the logical unit.

In particular embodiments, to determine the temperature of a logical unit based on multiple age characteristics, such as a version counter and a relocation counter, an average or weighted average of the characteristics can be determined and compared to a weighted average of the thresholds. The weighted average can be used if one of the characteristics provides a stronger indication of the temperature classification. The characteristic that provides a stronger indication can have a greater weight than other characteristics that provide weaker indications. For example, if the relocation count is found to provide a stronger indication than the version count, then the relocation count can be weighted by a factor of 0.75, and the version count can be weighted by a factor of 0.25 when determining a weighted average.

In the example of FIG. 5A, the temperature classifications determined for Units 24 and 25 based on the version counter age characteristic conflict with those determined based on the relocation counter age characteristic. As described above, Unit 24 is classified as cold data based on its version counter, but classified as hot data based on its relocation counter. Further, Unit 25 is classified as hot data based on its version counter, but classified as cold data based on its relocation counter. As described above, these conflicts can be resolved by, for example, giving precedence to the classification produced by one of the age characteristics (e.g., versions or relocations), by a heuristic such as selecting the classification that is farther from its threshold, by determining a weighted average, or by disregarding the classification and performing no action for the corresponding logical unit.

FIG. 5B illustrates a garbage collection target block 506B and a cold data target block 508B subsequent to the relocation of logical units 504 to the blocks 506B, 508B based on the classifications shown in FIG. 5A. Units 20, 21, and 23 have been relocated to block 506B because they are classified as hot blocks in this example. Further, Units 22, 24, and 25 have been relocated to block 508B because they are classified as cold blocks in this example.

FIG. 6A illustrates a flow diagram of an example method 600 to relocate a logical unit to a memory block that corresponds to a temperature classification of the logical unit using single-cursor addressing in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the temperature-aware memory management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 602, the processing logic identifies a source block of a media management event. The source block can be located in physical memory (e.g., in memory device 130). The media management event can be, for example, a garbage collection event, a write leveling event, or other event detected in the memory sub-system controller 115. One or more of the operations of method 600 can be performed in response to a garbage collection event or operation, or in response to another type of media management event or operation. One or more of the operations of method 600 can be performed using foreground processing, e.g., during times that the memory sub-system is processing write, erase, and/or read requests. At operation 604, the processing device reads a logical unit from a source block. At operation 606, the processing device determines a temperature classification of the logical unit.

At operation 608, the processing logic determines whether the temperature classification is a cold data classification. If the temperature classification is not cold, then at operation 610, the processing logic relocates the logical unit to a hot data block, such as a garbage collection target block. If the temperature classification is cold, then at operation 612, the processing logic stores an address of the logical unit in a cold data buffer. The method 600 can use the cold data buffer if a single cursor is available and used to address the hot data block in operation 630. (If multiple cursors are available, the method 620 shown in FIG. 6B can be used to address a hot data block and a cold data block.) At operation 614, the processing logic determines whether the cold data buffer size (e.g., the total size of the addresses stored in the cold data buffer) is greater than a threshold size (which can be the capacity of the buffer, or other suitable threshold). If not, then the processing device performs operation 604 to read another logical unit from a source block. Otherwise, if the cold data buffer size is greater than the threshold size, then at operation 616, the processing logic relocates the logical units having addresses stored in the cold data buffer to a cold data block. There can be multiple cold data blocks. For example, when a cold data block becomes full, another cold data block can be allocated and used to store subsequently identified cold logical units.

Alternatively, instead of storing the address of the logical unit in a cold data buffer and relocating the logical units when the buffer threshold is reached (as described above for operations 612-616), the method 600 can store an indication of the logical unit's classification in a data structure, which can subsequently be used to identify logical units of particular classifications and perform corresponding actions, such as relocating cold logical units to a cold data block. The data structure can be a bitmap, for example, that contains a bit corresponding to each logical unit (or, at least, to each valid logical unit). The value of a bit in the bitmap can be set by the method 600 to indicate whether the corresponding logical unit is classified as hot data or cold data based on the temperature classification determined at operation 606. During subsequent garbage collection events, for example, the bitmap can be used to retrieve the previously determined classification of valid logical units and relocate logical units that have been classified as cold (e.g., having a bit value corresponding to the cold classification) to dedicated cold data blocks.

FIG. 6B illustrates a flow diagram of an example method 620 to relocate a logical unit to a memory block that corresponds to a temperature classification of the logical unit using multi-cursor addressing in accordance with some embodiments of the present disclosure. The method 620 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 620 is performed by the temperature-aware memory management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 622, the processing logic identifies a source block of a media management event. The source block can be located in physical memory (e.g., in memory device 130). At operation 624, the processing logic reads a logical unit from the source block. At operation 626, the processing logic determines a temperature classification of the logical unit.

At operation 628, the processing logic determines whether the temperature classification is a cold data classification. If the temperature classification is not cold, then at operation 630, the processing logic relocates the logical unit to a hot data block, such as a garbage collection target block. If the temperature classification is cold, then at operation 632, the processing logic relocates the logical unit to a cold data block. The method can relocate the logical unit at either operation 630 or operation 632 using multiple cursors, e.g., one cursor to address the hot data block and another cursor to address the cold data block. There can be multiple cold data blocks. For example, when a cold data block becomes full, another cold data block can be allocated and used to store subsequently identified cold logical units.

FIG. 7 illustrates a flow diagram of an example method 700 to relocate a logical unit to a memory block that corresponds to a temperature classification of the logical unit using background processing in accordance with some embodiments of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the temperature-aware memory management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 702, the processing logic begins a background processing task. The method 700 can be understood as a cold-data coalescing task. The operations of method 700 can be performed in a background task, e.g. in response to a background idle time event. A background processing task can be performed when the memory sub-system controller 115 is not processing read, write, or erase operations, for example. At operation 704, the processing logic identifies a hot data block stored in physical memory. The hot data block can be, for example, a data block that contains at least one logical unit that is classified as hot data. As another example, the hot data block can be a data block that is not a designated cold data block to which the temperature-aware memory management component 113 relocates identified cold data logical units. At operation 706, the processing logic reads a logical unit from the identified hot data block. At operation 708, the processing logic determines a temperature classification of the logical unit. The temperature classification can be determined based on the logical unit's relocate counter, for example. Alternatively or additionally, the temperature classification can be determined based on the logical unit's version counter, or other age characteristic.

At operation 710, the processing logic determines whether the temperature classification is a cold data classification. If not, the processing device performs operation 706 to read another logical unit from the identified hot data block. If the temperature classification is a cold data classification, then at operation 712, the processing logic stores the address of the logical unit (read by operation 706) in a cold data buffer.

At operation 714, the processing logic determines whether the cold data buffer size (e.g., the size of the contents of the cold data buffer, which can be the total size of the addresses stored in the cold data buffer) is greater than a threshold size (which can be the capacity of the buffer, or other suitable threshold). If not, then the processing device performs operation 706 to read another logical unit from the identified hot data block. Otherwise, if the cold data buffer size is greater than the threshold size, then at operation 716, the processing logic relocates the logical units having addresses stored in the cold data buffer to a cold data block.

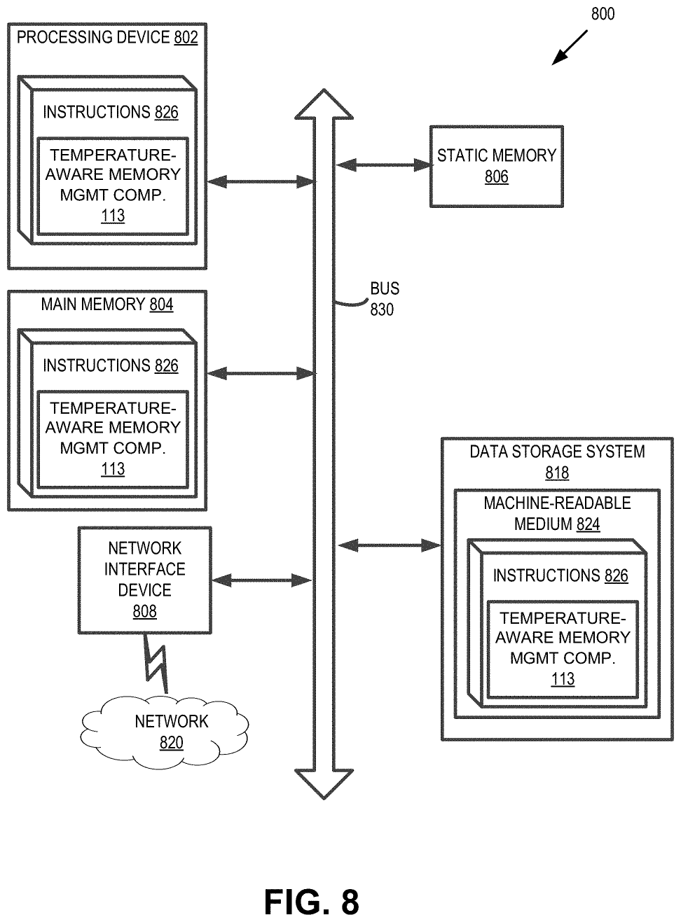

FIG. 8 illustrates an example machine of a computer system 800 within which a set of instructions, for causing the machine to perform any one or more of the methodologies discussed herein, can be executed. In some embodiments, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the temperature-aware memory management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or RDRAM, etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1.

In one embodiment, the instructions 826 include instructions to implement functionality corresponding to a temperature-aware memory management component (e.g., the temperature-aware memory management component 113 of FIG. 1). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
identifying at least one source physical memory block stored in the memory device, wherein the source physical memory block comprises at least one logical unit;
determining whether an age characteristic of the logical unit satisfies a threshold criterion;
determining a storage classification for the logical unit based on whether the age characteristic of the logical unit satisfies the threshold criterion, wherein the storage classification comprises one of a hot data classification or a cold data classification;
identifying a target physical memory block based on the storage classification determined for the logical unit; and
storing the logical unit in the identified target physical memory block.

2. The system of claim 1, wherein the age characteristic of the logical unit comprises a version count based on a number of times the data of the logical unit has been written to at least one physical block of the memory device, and wherein the threshold criterion comprises a threshold version count.

3. The system of claim 2, wherein the determined storage classification for the logical unit is the hot data classification when a difference between the version count of the logical unit and a current version value satisfies a threshold version difference.

4. The system of claim 3, wherein the determined storage classification for the logical unit is the hot data classification, and wherein the target physical memory block comprises a hot data physical memory block designated as storing data classified as hot data.

5. The system of claim 3, wherein the determined storage classification for the logical unit is the cold data classification when the difference between the version count of the logical unit and the current version count does not satisfy the threshold version difference.

6. The system of claim 5, wherein the determined storage classification for the logical unit is the cold data classification, and wherein the target physical memory block comprises a cold data physical memory block designated as storing data classified as cold data.

7. The system of claim 6, wherein storing each of the logical units at the target physical memory block identified for the logical unit comprises storing an address of the logical unit in a set of cold data logical unit addresses, wherein each logical unit identified by an address in the set of cold data logical unit addresses is moved to the cold data physical memory block when the set of cold data logical unit addresses satisfies a threshold size condition.

8. The system of claim 7, wherein the storing the address of the logical unit in the set of cold data logical unit addresses is performed by a background task during background idle time.

9. The system of claim 1, wherein the age characteristic of each logical unit comprises a relocation count based on a number of times the logical unit has been moved from a first physical memory block of the memory device to a second physical memory block of the memory device, wherein the relocation count is reset to an initial value when the logical unit is over-written in the memory device, and
wherein the determined storage classification for the logical unit is based on whether the relocation count satisfies a threshold relocation condition.

10. The system of claim 9, wherein the determined storage classification for the logical unit is the cold data classification when the relocation count satisfies a threshold relocation count.

11. The system of claim 10, wherein the determined storage classification for the logical unit is the hot data classification when the relocation count does not satisfy the threshold relocation count.

12. The system of claim 1, wherein the identifying at least one source physical memory block is performed by a garbage collection process in response to a garbage collection event.

13. The system of claim 1, wherein the logical unit corresponds to a page of the physical memory block.

14. A method comprising:
identifying at least one source physical memory block stored in a memory device, wherein the source physical memory block comprises at least one logical unit;
determining whether an age characteristic of the logical unit satisfies a threshold criterion;
determining a storage classification for the logical unit based on whether the age characteristic of the logical unit satisfies the threshold criterion, wherein the storage classification comprises one of a hot data classification or a cold data classification;
identifying a target physical memory block based on the storage classification determined for the logical unit; and
storing the logical unit in the identified target physical memory block.

15. The method of claim 14, wherein the age characteristic of the logical unit comprises a version count based on a number of times the data of the logical unit has been written to at least one physical block of the memory device, and wherein the threshold criterion comprises a threshold version count.

16. The method of claim 15, wherein the determined storage classification for the logical unit is the hot data classification when a difference between the version count of the logical unit and a current version value satisfies a threshold version difference.

17. A non-transitory computer-readable storage medium comprising instructions that, when executed by a processing device, cause the processing device to perform operations comprising:
identifying at least one source physical memory block stored in a memory device, wherein the source physical memory block comprises at least one logical unit;
determining, based on one or more age-related counters associated with the logical unit, that the logical unit is to be stored in a designated cold-data physical memory block; and
storing the logical unit in the cold-data physical memory block.

18. The non-transitory computer-readable storage medium of claim 17, wherein the age-related counters comprise a version count based on a number of times the data of the logical unit has been written to at least one physical block of the memory device, and
wherein the logical unit is to be stored in the designated cold-data physical memory block when the version count satisfies a threshold version count.

19. The non-transitory computer-readable storage medium of claim 17, wherein the age-related counters comprise a relocation count based on a number of times the logical unit has been moved from a first physical memory block of the memory device to a second physical memory block of the memory device, wherein the relocation count is reset to an initial value when the logical unit is over-written in the memory device, and
wherein the logical unit is to be stored in the designated cold-data physical memory block when the relocation count satisfies a threshold relocation count.

20. The non-transitory computer-readable storage medium of claim 17, wherein the processing device is to perform operations further comprising:
determining, based on the one or more age-related counters associated with the logical unit, that the logical unit is to be stored in a designated hot-data physical memory block; and
storing the logical unit in the designated hot-data physical memory block.
